(19) United States
(12) Patent Application Publication
(10) Pub. No.: US 2014/0222432 A1
(43) Pub. Date: Aug. 7, 2014

(54) WIRELESS COMMUNICATION CHANNEL OPERATION METHOD AND SYSTEM OF PORTABLE TERMINAL

(71) Applicant: Samsung Electronics Co., Ltd., Gyeonggi-do (KR)

(72) Inventors: Jihyun Ahn, Seoul (KR); Sora Kim, Seoul (KR); Jinyong Kim, Gyeonggi-do (KR); Hyunkyoung Kim, Seoul (KR); Heewoon Kim, Gyeonggi-do (KR); Yumi Ahn, Gyeonggi-do (KR)

(73) Assignee: Samsung Electronics Co., Ltd., Gyeonggi-do (KR)

(21) Appl. No.: 14/175,557

(22) Filed: Feb. 7, 2014

(30) Foreign Application Priority Data
Feb. 7, 2013 (KR) 10-2013-0013757

(51) Int. Cl. G10L 15/18; G10L 15/22; G06K 9/00

(52) U.S. Cl. CPC G10L 15/1822; G06K 9/00308; G10L 15/22
USPC 704/257; 704/275

(57) ABSTRACT

A voice talk function-enabled terminal and voice talk control method for outputting distinct content based on the current emotional state, age, and gender of the user are provided. The mobile terminal supporting a voice talk function includes a display unit, an audio processing unit, which selects content corresponding to a first criterion associated with a user in response to a user input, determines a content output scheme based on a second criterion associated with the user, and outputs the selected content through the display unit and audio processing unit according to the content output scheme.

### PRIORITY

This application claims priority under 35 U.S.C. §119(a) to a Korean Patent Application filed on Feb. 7, 2013 in the Korean Intellectual Property Office and assigned Serial No. 10-2013-0013757, the entire disclosure of which is incorporated herein by reference.

### BACKGROUND OF THE INVENTION

1. Field of the Invention

The present invention relates to a voice talk function-enabled mobile terminal and voice talk control method, and more particularly, t to a voice talk function-enabled terminal and voice talk control method for outputting content distinctly according to a current emotion, age, and gender of the user.

2. Description of the Related Art

The conventional voice talk function operates in such a way that an answer to a user's question is selected from a basic answer set provided by the terminal manufacturer. Accordingly, the voice talk function is limited in that the same question is answered with the same answer regardless of the user. This means that when multiple users use the voice talk function-enabled mobile terminal, the conventional voice talk function does not provide an answer optimized per user.

### SUMMARY OF THE INVENTION

The present invention has been made to address at least the problems and disadvantages described above, and to provide at least the advantages described below. Accordingly, an aspect of the present invention provides a mobile terminal for outputting content reflecting a user's current emotional state, age, and gender, and a voice talk control method thereof.

In accordance with an aspect of the present invention, a mobile terminal supporting a voice talk function is provided. The terminal includes a display unit, an audio processing unit, and a control unit configured to select content corresponding to first criterion associated with a user in response to a user input, determine a content output scheme based on a second criterion associated with the user, and output the selected content through the display unit and audio processing unit according to the content output scheme.

In accordance with another aspect of the present invention, a voice talk method of a mobile terminal is provided. The method includes selecting content corresponding to a first criterion associated with a user in response to a user input, determining a content output scheme based on a second criterion associated with the user, and outputting the selected content through a display unit and an audio processing unit of the mobile terminal according to the content output scheme.

### BRIEF DESCRIPTION OF THE DRAWINGS

The above and other aspects, features and advantages of embodiments of the present invention will become apparent from the following detailed description taken in conjunction with the accompanying drawings, in which:

FIG. 1 is a block diagram illustrating a configuration of the mobile terminal 100 according to an embodiment of the present invention;

FIG. 2 is a flowchart illustrating a voice talk function control method according to an embodiment of the present invention;

FIG. 3 is a table mapping emotional states and contents for use in the voice talk control method according to an embodiment of the present invention;

FIGS. 4 and 5 are diagrams of screen displays illustrating content output based on a first criterion according to an embodiment of the present invention;

FIG. 6 is a flowchart illustrating details of the first criterion acquisition step of FIG. 2;

FIG. 7 is a table mapping emotional states and contents for use in the voice talk control method according to an embodiment of the present invention;

FIGS. 8 and 9 are diagrams of screen displays illustrating content output based on the first criterion according to an embodiment of the present invention;

FIG. 10 is a table mapping emotional states and contents for use in the voice talk control method according to an embodiment of the present invention;

FIG. 11 is a diagram of screen displays illustrating content output based on the first criterion according to an embodiment of the present invention; and

FIG. 12 is a schematic diagram illustrating a system for voice talk function of the mobile terminal according to an embodiment of the present invention.

### DETAILED DESCRIPTION OF EMBODIMENTS OF THE PRESENT INVENTION

The present invention will be described more fully hereinafter with reference to the accompanying drawings, in which illustrative embodiments of the invention are shown. This invention may, however, be embodied in many different forms and should not be construed as limited to the embodiments set forth herein. Rather, these embodiments are provided so that the description of this invention will be thorough and complete, and will fully convey the scope of the invention to those skilled in the art. The present invention will be defined by the appended claims.

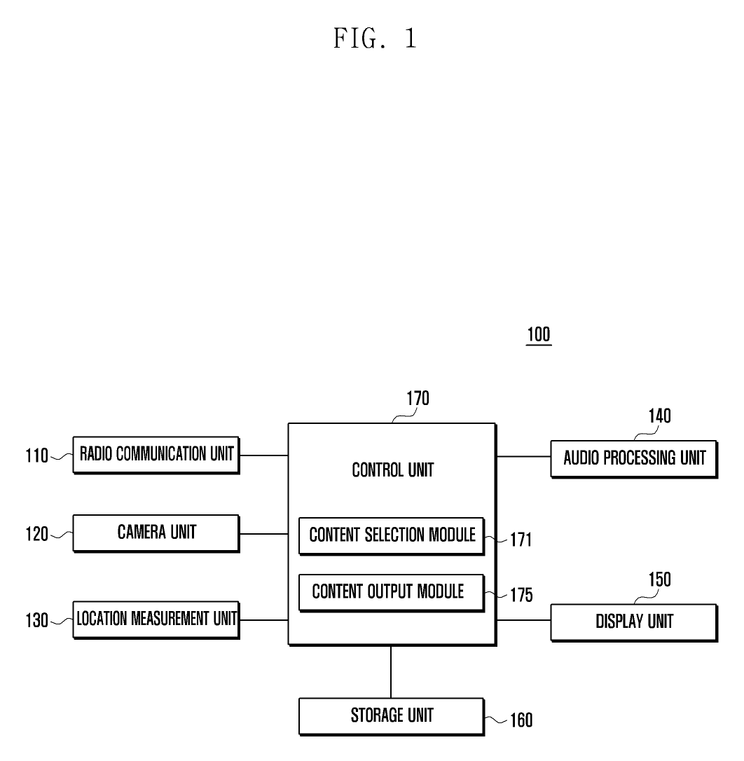

FIG. 1 is a block diagram illustrating a configuration of the mobile terminal 100 according to an embodiment of the present invention.

Referring to FIG. 1, the mobile terminal 100 includes a radio communication unit 110, a camera unit 120, a location measurement unit 130, an audio processing unit 140, a display unit 150, a storage unit 160, and a control unit 170.

The radio communication unit 110 transmits/receives radio signals carrying data. The radio communication unit 110 may include a Radio Frequency (RF) transmitter configured to up-convert and amplify the transmission signals, and a RF receiver configured to low noise amplify and down-convert the received signals. The radio communication unit 110 transfers the data received over a radio channel to the control unit 170 and transmits the data output from the control unit 170 over the radio channel.

The camera unit 120 receives video signals. The camera unit 120 processes the video frames of still and motion images obtained by an image sensor in the video conference mode or image shooting mode. The camera unit 120 may output the processed video frame to the display unit 150. The video frame processed by the camera unit 120 may be stored in the storage unit and/or transmitted externally by means of the radio communication unit 110.

The camera unit 120 may include two or more camera modules depending on the implementation of the mobile terminal 100. For example, the mobile terminal 100 may include a camera facing the same direction as the screen of the display unit 150 and another camera facing the opposite direction from the screen.

The location measurement unit 130 may be provided with a satellite signal reception module to measure the current location of the mobile terminal 100 based on the signals received from satellites. By means of the radio communication unit 110, the location measurement unit 130 may also measure the current location of the mobile terminal 100 based on the signals received from an internal or external radio communication apparatus inside of a facility.

The audio processing unit 140 may be provided with a codec pack including a data codec for processing packet data and audio codec for processing audio signal such as voice. The audio processing unit 140 may convert digital audio signals to analog audio signals by means of the audio codec so as to output the analog signal through a speaker (SPK) and convert the analog signal input through a microphone (MIC) to the digital audio signals.

The display unit 150 displays menus, input data, function configuration information, etc. to the user in a visual manner. The display unit 150 outputs a booting screen, a standby screen, a menu screen, a telephony screen, and other application execution screens.

The display unit 150 may be implemented with one of Liquid Crystal Display (LCD), Organic Light Emitting Diodes (OLED), Active Matrix OLED (AMOLED), flexible display, and a 3 Dimensional (3D) display.

The storage unit 160 stores programs and data necessary for operation of the mobile terminal 100 and may be divided into a program region and a data region. The program region may store basic programs for controlling the overall operation of the mobile terminal 100, an Operating System (OS) for booting the mobile terminal 100, multimedia content playback applications, and other applications for executing optional functions such as voice talk, camera, audio playback, and video playback. The data region may store the data generated in the state of using the mobile terminal 100 such as still and motion images, phonebook, and audio data.

The control unit 170 controls overall operations of the components of the mobile terminal 100. The control unit 170 receives a user's speech input through the audio processing unit 140 and controls the display unit 150 to display the content corresponding to the user's speech in the voice talk function executed according to the user's manipulation The control unit 170 also may play content corresponding to the user's speech through the audio processing unit 140. Here, the content may include at least one of multimedia content such as text, picture, audio, movie, and video clip, and information such as weather, recommended locations, and favorite contact.

In more detail, the control unit 170 recognizes the user's speech to obtain the corresponding text. Next, the control unit 170 retrieves the content corresponding to the text and outputs the content through at least one of the display unit 150 and audio processing unit 160. Finally, the control unit 170 may check the meaning of the text to retrieve the corresponding content among related content stored in the storage unit 160. In this way, using interactive speech communication, the user may be provided with the intended information through the related stored content. For example, if the user speaks “Today's weather?” the mobile terminal 100 receives the user's speech input through the audio processing unit 140. Then the mobile terminal 100 retrieves the content (weather information) corresponding to the text “today's weather” acquired from the user's speech and outputs the retrieved content through at least one of the display unit 150 and the audio processing unit 140.

Particularly, in an embodiment of the present invention, the control unit 170 may select the content to be output through the display unit 150 and/or the audio processing unit 140 depending on the user's current emotion, age, and gender. In order to accomplish this, the control unit 170, according to an embodiment of the present invention, may include a content selection module 171 and a content output module 175.

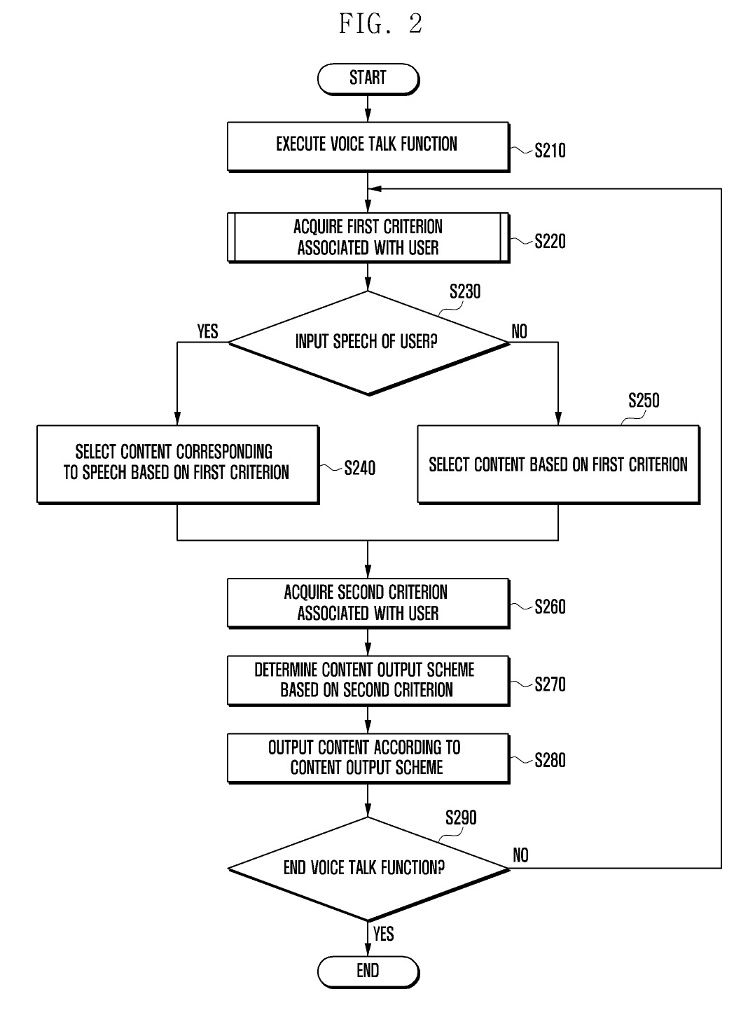

FIG. 2 is a flowchart illustrating a voice talk function control method according to an embodiment of the present invention.

Referring to FIG. 2, if the voice talk function is executed at step S210, the content selection module 171 acquires a first criterion associated with the user at step S220. Here, the first criterion may include the current emotional state of the user. The emotional state denotes a mood or feeling felt such as joy, sorrow, anger, surprise, etc.

The content selection module 171 determines whether a user's speech input is detected at step S230. If a user's speech input is detected through the audio processing unit 140, the content selection module 171 selects the content corresponding to the user' speech input based on the first criterion at step S240. In more detail, the content selection module 171 obtains the phrase from the user's speech. Next, the content selection module 171 retrieves the contents corresponding to the phrase. Next, the content selection module 171 selects one of the contents using the emotional state information predetermined based on the first criterion. Here, the emotional state-specific content information may be preconfigured and stored in the storage unit 160. The content selection module 171 also may retrieve the contents first based on the first criterion and then select one of the contents corresponding to the phrase.

Otherwise, if no user's speech input is detected at step S230, the content selection module 171 selects the content based on the first criterion at step S250.

If the content is selected, the content output module 175 acquires a second criterion associated with the user at step S260. Here, the second criterion may include at least one of the user's age and gender. The user's age may be the accurate user's age or one of predetermined age groups. For example, the user's age may be indicated with a precise number such as 30 or 50, or with an age group such as 20's, 50's, child, adult, and elder.

In detail, the content output module receives the user's face image from the camera unit 120. The content output module 175 may acquire the second criterion automatically from the user's face image based on per-age group or per-gender average face information stored in the storage unit 160. The content output module 175 also receives the user's speech input through the audio processing unit 140. Next, the content output module 175 may acquire the second criterion from the user's speech using the per-age group or per-gender average speech information. The content output module 175 also may acquire the second criterion based on the words constituting the phrase obtained from the user's speech. At this time, the content output module 165 may acquire the second criterion using the per-age group or per-gender words. For example, if a phrase “I want new jim-jams” is acquired from the user's speech, it is possible to judge the user as a child based on the word “jim-jams.”

The content output module 175 may acquire the second criterion based on both the user's face image and speech. Although the description is directed to the case where the content output module 175 acquires the second criterion based on the user's face image and speech, the various embodiments of the present invention are not limited thereto, but may be embodied for the user to input the second criterion. In this case, the second criterion input by the user may be stored in the storage unit 160. The content output module 175 performs predetermined functions based on the second criterion stored in the storage unit 160.

If the second criterion is acquired, the content output module 175 determines a content output scheme based on the second criterion at step S270. That is, the content output module 175 determines the content output scheme by changing the words constituting the content selected by the content selection module 171, output speed of the selected content, and output size of the selected content.

In more detail, the content output module 175 may change the words constituting the selected content to words appropriate for the second criterion based on the per-age group word information or per-gender word information. For example, if the content includes “Pajamas store” and if the user belongs to the age group “children,” the content output module 175 changes the word “Pajamas” for the word “Jim jams” appropriate for children.

The content output module 175 determines the output speed of the selected content based on the per-age group output speed information or per-gender output speed information stored in the storage unit 160. For example, if the user belongs to the age group of “child” or “elder”, the content output module 175 may decrease the speech playback speed of the selected content.

The content output module 175 also determines the output size of the selected content based on the per-age group output size information or per-gender output size information. For example, if the user belongs to the age group “elder”, the content output module 175 may increase the output volume of the selected content and the display size (e.g. font size) of the selected content based on the per-age group output size information. The storage unit 160 stores a table which contains a mapping of the age group or gender to the content output scheme (content output speed and size), and the content output module 175 determines the output scheme of the selected content based on the data stored in the table mapping. If the content output scheme is selected, the content output module 175 outputs the content selected by the content selection module 171 through the display unit 150 and audio processing unit 140 according to the content output scheme at step S280.

Afterward, if a voice talk function termination request is detected at step S290, the control unit 170 ends the voice talk function. If the voice talk function termination request is not detected at step S290, the control unit 170 returns the procedure to step S220.

As described above, the voice talk control method of the invention selects the content appropriate for the current emotional state of the user and determines the content output scheme according to the user's age and/or gender so as to provide the user with the customized content. This method makes it possible to provide more realistic voice talk functionality.

Meanwhile if the phrase acquired from the user's speech input through the audio processing unit 140 is a request for changing the content output scheme, the content output module 175 changes the content output scheme according to the phrase. For example, after the content has been output according to the content output scheme determined based on the second criterion, if the user speaks a phrase “Can you speak faster and more quietly?,” the control output module 175 increases the speech playback speed one step and decreases the audio volume one step.

The content output module 175 may store the changed content output scheme in the storage unit 160. Afterward, the content output module 175 changes the content output scheme determined based on the second criterion using the previously stored content output scheme history. The content output module 175 may output the selected content according to the changed content output scheme.

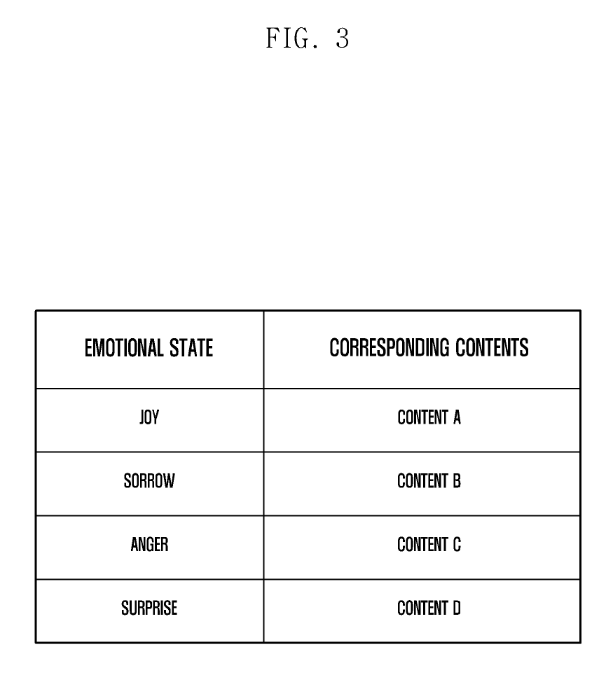

A content output procedure according to an embodiment of the invention is described hereinafter with reference to FIGS. 3 to 5.

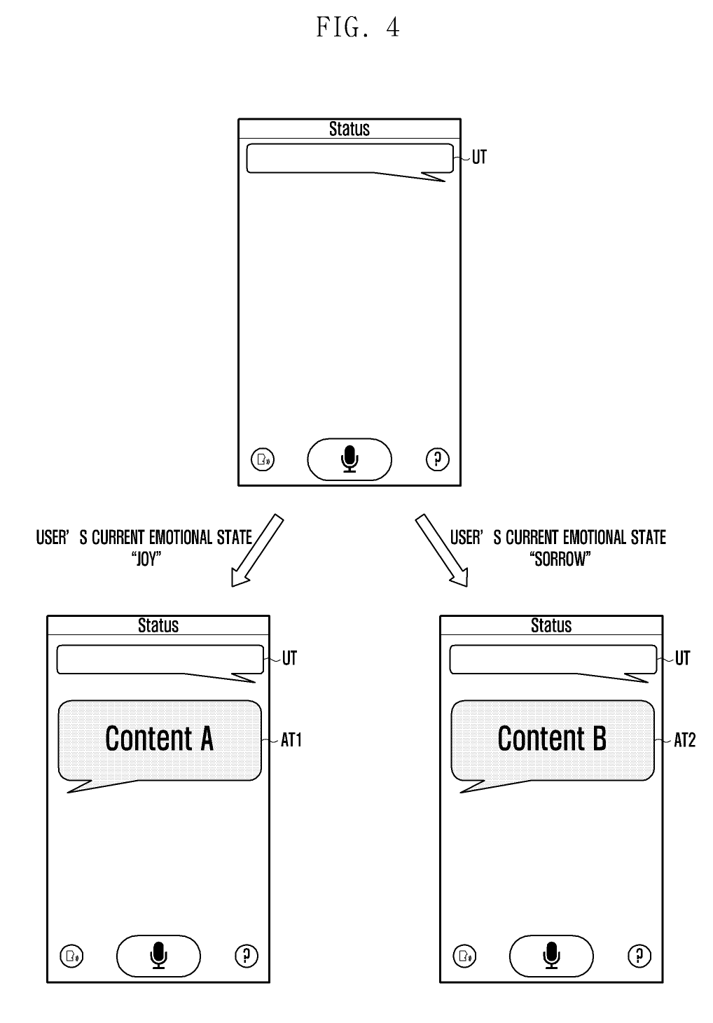

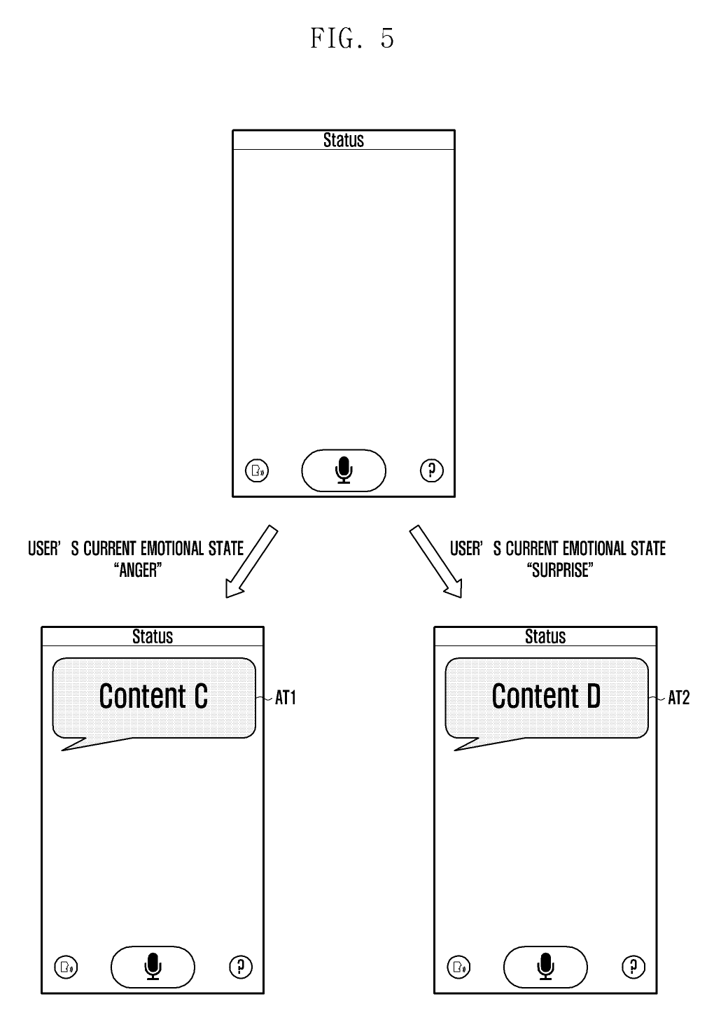

FIG. 3 is a table mapping emotional states and contents for use in the voice talk control method according to an embodiment of the present invention. FIGS. 4 and 5 are diagrams of screen displays illustrating content output based on the first criterion according to an embodiment of the present invention.

Referring to FIG. 3, the contents are pre-mapped to the emotional states. The emotional state “joy” is mapped to the content A, the emotional state “sorrow” to content B, the emotional state “anger” to content C, and the emotional state “surprise” to content D. These emotional states and contents are pre-mapped and stored in the storage unit 160.

The content selection module 171 may select the content appropriate for the first criterion (user's current emotional state) among per-emotional state contents.

Referring to FIG. 4, on the basis of the phrase UT acquired from the user's speech input through the audio processing unit 140 and the first criterion (user's current emotional state), the content selection module 171 selects content A (AT1) for the emotional state “joy” and content B (AT2) for the emotional state “sorrow.”

Referring to FIG. 5, the content selection module 171 selects content C (AT1) for the emotional state “anger” and content D (AT2) for the emotional state “surprise,” on the basis of the first criterion (user's current emotional state).

Although FIG. 3 is directed to a mapping of one content item per emotional state, the present invention is not limited thereto but may be embodied to map multiple content items per emotional state. In this case, the content selection module 171 may select one of the multiple contents corresponding to the first criterion (user's current emotional state) randomly.

The contents may be grouped per emotional state. A “content group” denotes a set of contents having the same/similar property. For example, a content group may be classified into one of “action” movie content group, “R&B” music content group, etc. In this case, the content selection module 171 may select one of the contents of the content group fulfilling the first criterion (user's current emotional state) randomly.

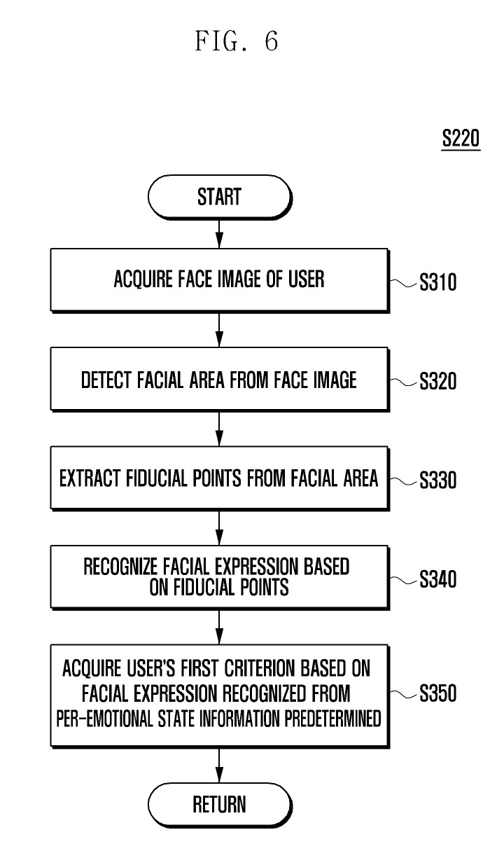

FIG. 6 is a flowchart illustrating details of the first criterion acquisition step of FIG. 2.

Referring to FIG. 6, the content selection module 171 acquires a user's face image from the camera unit 120 at step S310 and detects the face area from the face image at step S320. That is, the content selection module 171 detects the face area having eyes, nose, and mouth.

Next, the content selection module 171 extracts the fiducial points of the eyes, nose, and mouth at step S330 and recognizes the facial expression based on the fiducial points at step S340. That is, the content selection module 171 recognizes the current expression of the user based on per-expression fiducial point information stored in the storage unit 160.

Afterward, the content selection module 171 retrieves the first criterion automatically based on the expression determined based on the predetermined per-emotional state expression information at step S350. Here, the per-emotional state expression information may be pre-configured and stored in the storage unit 160.

Although the description is directed to the case where the content selection module 171 acquires the first criterion based on the user's face image, the present invention is not limited thereto but may be embodied for the user to input the first criterion.

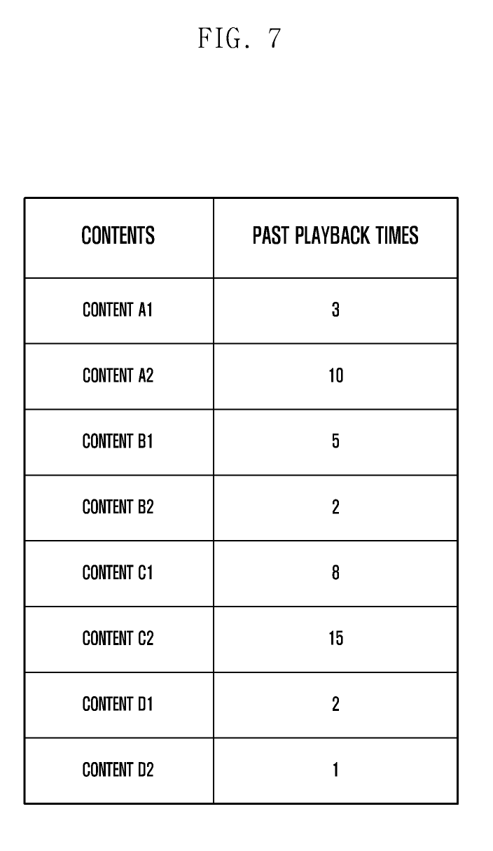

Another content output procedure according to an embodiment of the present invention is described hereinafter with reference to FIGS. 7 to 9.

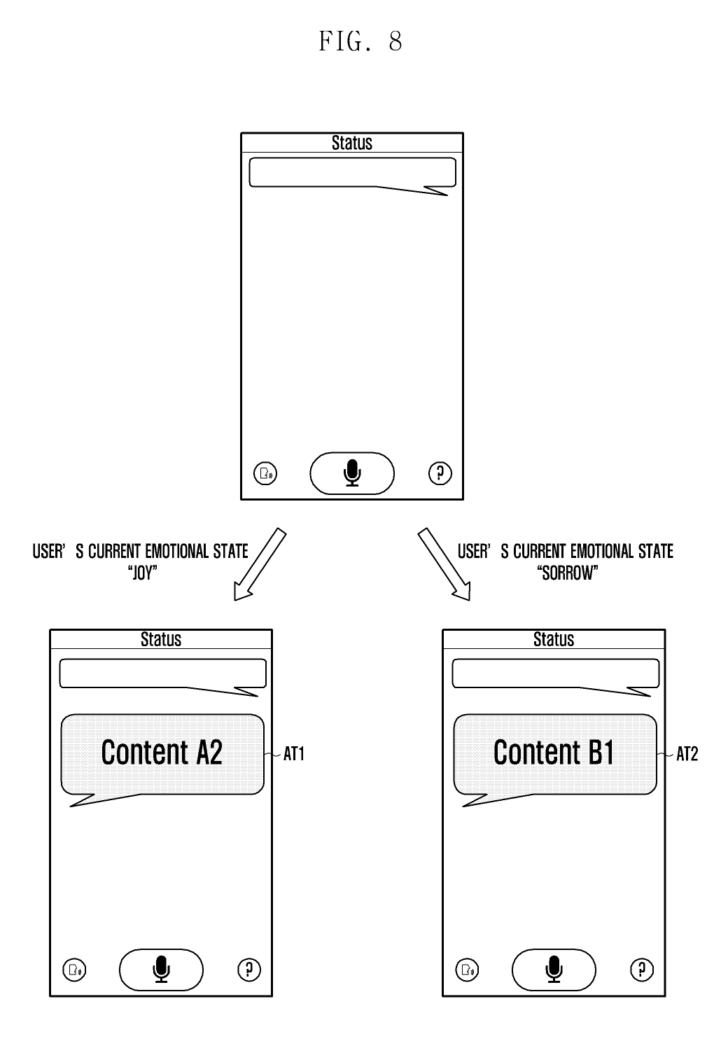

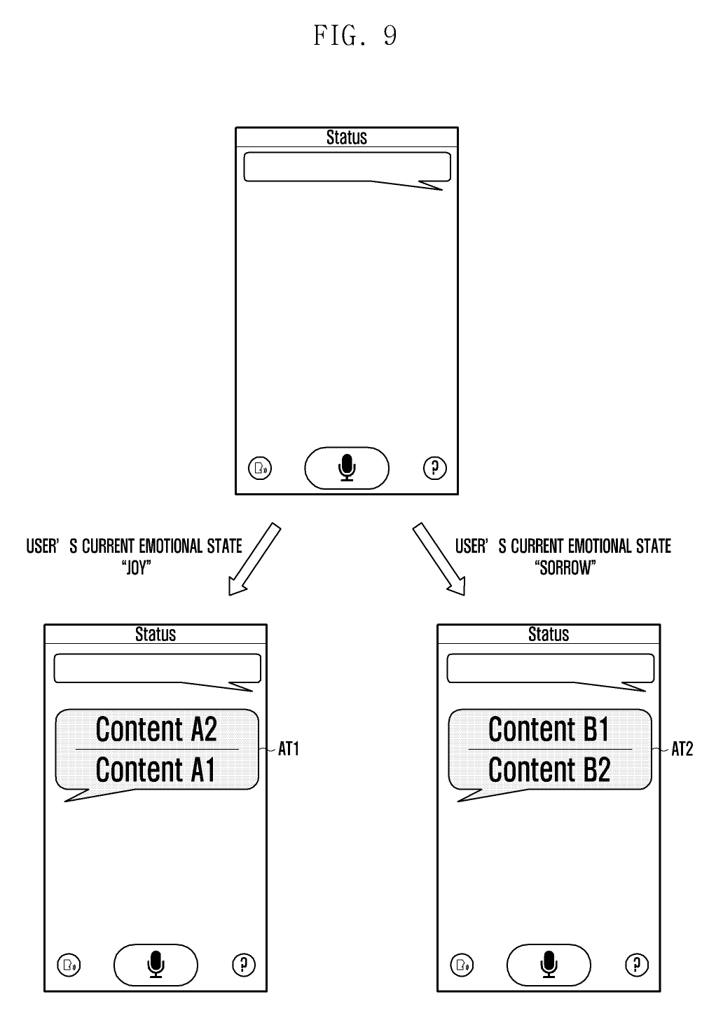

FIG. 7 is a table mapping emotional states and contents for use in the voice talk control method according to an embodiment of the present invention. FIGS. 8 and 9 are diagrams of screen displays illustrating content output based on the first criterion according to an embodiment of the present invention.

The content selection module 171 may select content based on the first criterion (user's current emotional state) using the user's past content playback history. The past content playback history is stored in the storage unit 160 and updated whenever the content is played according to the user's manipulation.

Referring to FIG. 7, the numbers of playback or the respective content items are stored in the storage unit 160. The content A1 is played three times, the content A2 ten times, the content B1 five times, the content B2 twice, the content C1 eight times, the content C2 fifteen times, the content D1 twice, and the content D2 once. The contents A1 and A2 are mapped to the emotional state “joy,” the contents B1 and B2 to the emotional state “sorrow,” the contents C1 and C2 to the emotional state “anger,” and the contents D1 and D2 to the emotional state “surprise” (see FIG. 3).

The content selection module 171 may select one of the multiple contents appropriate for the first criterion (user's current emotional state) based on the past content playback history.

Referring to FIG. 8, if the first criterion (user's current emotional state) is “joy,” the content selection module 171 selects the content A2 (AT1) which has been played more frequently among the contents A1 and A2 mapped to the first criterion (user's current emotional state). If the first criterion (user's current emotional state) is “sorrow,” the content selection module 171 selects the content B1 (AT2) which has been played more frequently among the contents B1 and B2 mapped to the first criterion (user's current emotional state).

At this time, the content selection module 171 may select the multiple contents mapped to the first criterion (user's current emotional state). Then the content output module 175 may determine the output positions of the multiple contents based on the past contents playback history.

Referring to FIG. 9, if the first criterion (user's current emotional state) is “joy,” the content selection module 171 selects both the contents A1 and A2 as the contents (AT1) fulfilling the first criterion (user's current emotional state). Then the content output module 175 arranges the content A1 below the content A2 (AT1) which has been played more frequently. If the first criterion (user's current emotional state) is “sorrow,” the content selection module 171 selects both the contents B1 and B2 as the contents (AT2) fulfilling the first criterion (user's current emotional state). Then the content output module 175 arranges the content B2 below the content B1 (AT2) which has been played more frequently.

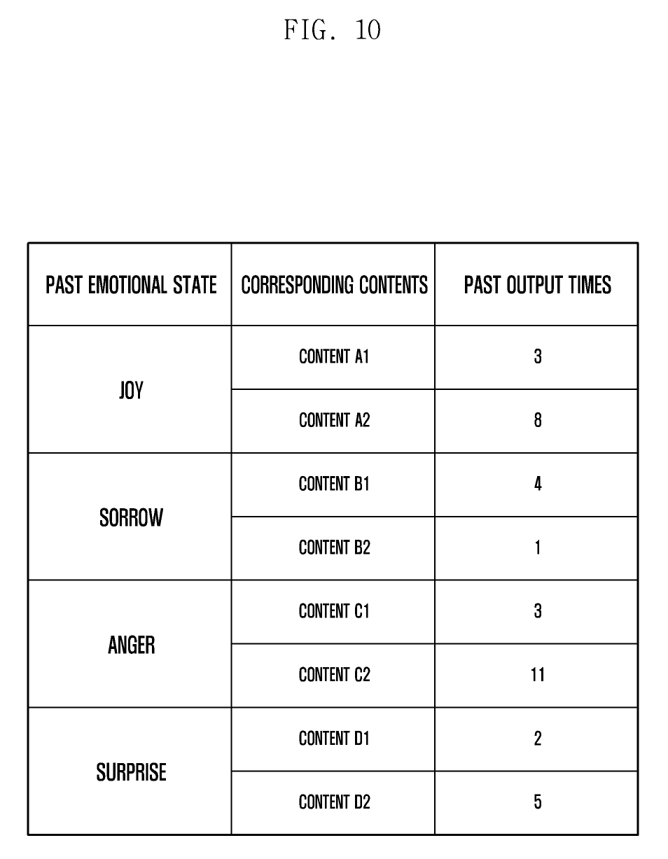

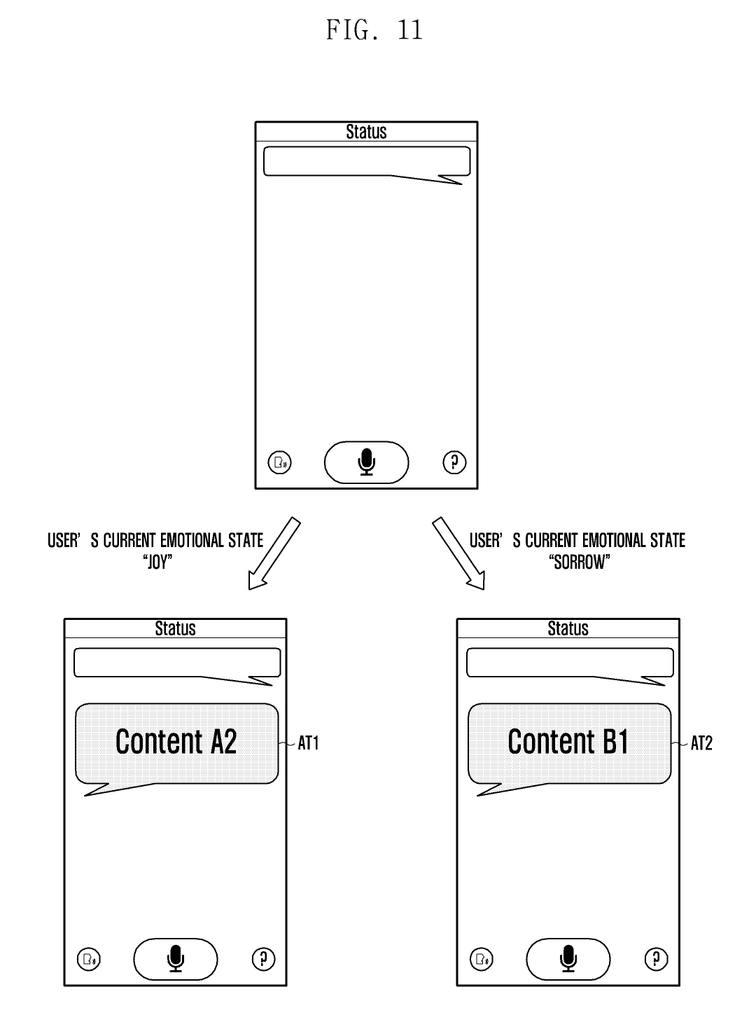

Another content output procedure according to an embodiment of the present invention is described hereinafter with reference to FIGS. 10 and 11.

FIG. 10 is a table mapping emotional states and contents for use in the voice talk control method according to an embodiment of the present invention. FIG. 11 is a diagram of screen displays for illustrating content output based on the first criterion according to an embodiment of the present invention.

The content selection module 171 may select the content based on the first criterion (user's current emotional state) and the user's past emotional state-based content output history. The user's past emotional state-based content output history is stored in the storage unit 160 and updated whenever the content is output in accordance with the user's emotional state while the voice talk function is activated.

Referring to FIG. 10, the numbers of past emotional state-based output times of the contents are stored in the storage unit 160. The content A1 has been output three times, the content A2 eight times, the content B1 four times, the content B2 once, the content C1 three times, the content C2 eleven times, the content D1 twice, and the content D2 five times.

The content selection module 171 may select one of the multiple contents mapped to the first criterion (user's current emotional state) using the past emotional state-based content output history.

Referring to FIG. 11, if the first criterion (user's current emotional state) is “joy,” the content selection module 171 selects the content A2 which has been output more frequently in association with the user's past emotional state as the content (AT1) corresponding to the first criterion among the contents A1 and A2. If the first criterion (user's current emotional state) is “sorrow,” the content selection module 171 selects the content B1 which has been output more frequently in association with the user's past emotional state as the content (AT2) corresponding to the first criterion (user's current emotional state) among the contents B1 and B2.

The content selection module 171 may select all the contents mapped to fulfilling the first criterion (user's current emotional state). Then the content output module 175 determines the output positions of the multiple contents using the past emotional state-based content output history. For example, if the first criterion (user's current emotional state) is “joy,” the content selection module 171 selects both the contents A1 and A2 as the contents corresponding to the first criterion (user's current emotional state). Then the content output module 175 arranges the content A1 below the content A2 which has been played more frequently in accordance to the past user's emotional state.

Another content output procedure according to an embodiment of the present invention is described hereinafter.

The content selection module 171 may select contents based on the first criterion (user's current emotional state) using current location information of the mobile terminal 100 which is acquired through the location measurement unit 130. In more detail, the content selection module 171 acquires multiple contents based on the first criterion (user's current emotional state). Next, the content selection module 171 selects the content associated with the area within a predetermined radius around the current location of the mobile terminal among the acquired contents. For example, if the content is information about recommended places (restaurant, café, etc.), the content selection module 171 may select the content appropriate for the current location of the mobile terminal 100 based on the current location information of the mobile terminal.

Of course, the content selection module 171 may acquire multiple content associated with the area within the predetermined radius around the current location of the mobile terminal and then select the content fulfilling the first criterion (user's current emotional state) among the acquired contents.

Although the description has been directed to the case where the control unit 170, content selection module 171, and content output module 175 are configured separately and responsible for different functions, the present invention is not limited thereto but may be embodied in such a manner that the control unit, the content selection module and the content output module function in an integrated fashion.

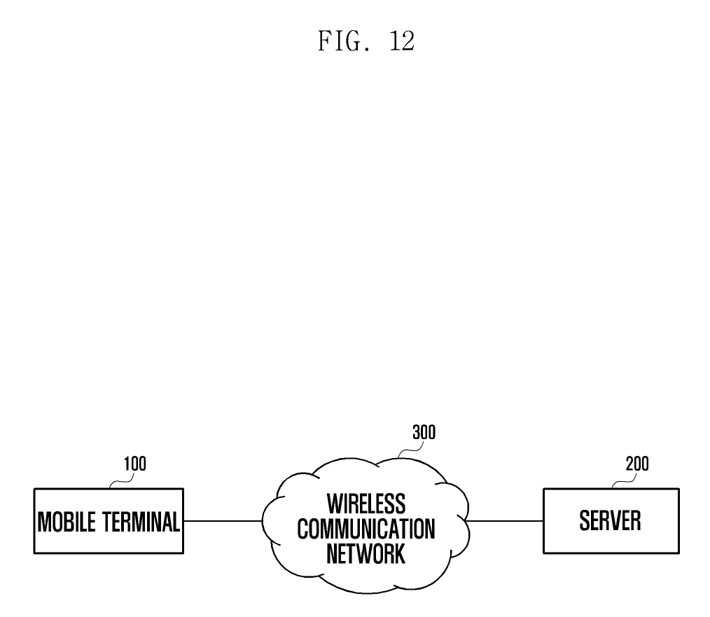

FIG. 12 is a schematic diagram illustrating a system for voice talk function of the mobile terminal according to an embodiment of the present invention.

Since the mobile terminal 100 here is identical to the mobile terminal described above with reference to FIG. 1, a detailed description of mobile terminal 100 is omitted herein. The mobile terminal 100 according to an embodiment of the present invention is connected to a server 200 through a wireless communication network 300.

In the above described embodiments, the control unit 170 of the mobile terminal 100 performs the first criterion acquisition operation, the first criterion-based content selection operation, the second criterion acquisition operation, and the content output scheme determination operation.

In this embodiment, however, the control unit 170 of the mobile terminal 100 exchanges data with the server by means of the radio communication unit 100, and performs the first criterion acquisition operation, the first criterion-based content selection operation, the second criterion acquisition operation, and the content output scheme determination operation.

For example, the control unit 170 of the mobile terminal 100 provides the server 200 with the user's face image input through the camera unit 120 and the user's speech input through the audio processing unit 140. Then the server 200 acquires the first and second criteria based on the user's face image and user's speech. The server 200 provides the mobile terminal 100 with the acquired first second criteria.

Although the description has been made under the assumption of a single user, the present invention is not limited thereto, and it can also be applied to the case where multiple users use the mobile terminal 100. In this case, it is necessary to add an operation to identify the current user of the mobile terminal 100. The user's past content output scheme history, user's past content playback history, and user's past emotional state-based content output history may be stored per user. Accordingly, even when multiple users use the mobile terminal 100, it is possible to provide user-specific content.

As described above, the voice talk function-enabled mobile terminal and voice talk control method of the present invention is capable of selecting any content appropriate for the user's current emotional state and determining a content output scheme according to the user's age and gender. Accordingly, it is possible to provide the contents customized for individual user. Accordingly, the present invention is capable of implementing realistic voice talk function.

Although embodiments of the invention have been described in detail hereinabove, a person of ordinary skill in the art will understand and appreciate that many variations and modifications of the basic inventive concept described herein will still fall within the spirit and scope of the invention as defined in the following claims and their equivalents.

What is claimed is:

1. A mobile terminal supporting a voice talk function, the terminal comprising:
a display unit;
an audio processing unit;
a control unit configured to select content corresponding to a first criterion associated with a user in response to a user input, determine a content output scheme based on a second criterion associated with the user, and output the selected content through the display unit and audio processing unit according to the content output scheme.

2. The terminal of claim 1, wherein the first criterion is a current emotional state of the user, and the second criterion is user information including at least one of age and gender of the user.

3. The terminal of claim 1, wherein the control unit selects the content corresponding to the first criterion, the corresponding content comprises at least one predetermined content according to the emotional state of the user.

4. The terminal of claim 1, wherein the control unit selects the content based on the first criterion and user's past content playback history.

5. The terminal of claim 1, wherein the control unit selects the content based on the first criterion and current location information of the terminal.

6. The terminal of claim 1, wherein the control unit selects the content based on content output history in association with past emotional states of the user.

7. The terminal of claim 1, wherein the audio processing unit receives speech of the user, and the control unit selects the content corresponding to a phrase acquired from the speech based on the first criterion.

8. The terminal of claim 7, wherein the control unit acquires a second criterion based on words constituting the phrase.

9. The terminal of claim 1, wherein the control unit changes at least one of words constituting the content, output speed of the content, and output size of the content based on the second criterion and outputs the content according to the content output scheme.

10. The terminal of claim 1, wherein the audio processing unit receives speech of the user, and the control unit changes, when a phrase acquired from the speech is a request for changing the content output scheme, the content output scheme.

11. The terminal of claim 1, wherein the control unit changes the content output scheme determined based on the second criterion using past content output scheme history of the user and outputs the content according to the changed content output scheme.

12. The terminal of claim 1, further comprising a camera unit which takes a face image of the user, wherein the control unit automatically acquires the first criterion based on the face image of the user.

13. The terminal of claim 12, wherein the control unit acquires the first criterion from predetermined per-emotional state expression information based on facial expressions acquired from the user's face image.

14. The terminal of claim 1, further comprising a camera unit which takes a face image of the user, wherein the audio processing unit receives speech of the user and the control unit automatically acquires the second criterion based on at least one of the user's face image and speech.

15. The terminal of claim 1, wherein the control unit receives the first and second criteria through the audio processing unit.

16. A voice talk method of a mobile terminal, the method comprising:
selecting content corresponding to a first criterion associated with a user in response to a user input;
determining a content output scheme based on a second criterion associated with the user; and
outputting the selected content through a display unit and an audio processing unit of the mobile terminal according to the content output scheme.

17. The method of claim 16, wherein the first criterion is a current emotional state of the user, and the second criterion is user information including at least one of age and gender of the user.

18. The method of claim 16, wherein selecting the content comprises selecting the content corresponding to the first criterion, the corresponding content comprises at least one predetermined content according to the emotional state of the user.

19. The method of claim 16, wherein selecting the content comprises selecting the content based on the first criterion and the user's past content playback history.

20. The method of claim 16, wherein selecting the content comprises selecting the content based on the first criterion and current location information of the terminal.

21. The method of claim 16, wherein selecting the content comprises selecting the content based on content output history in association with past emotional states of the user.

22. The method of claim 16 further comprising receiving speech of the user, wherein selecting the content comprises selecting the content corresponding to a phrase acquired from the speech based on the first criterion.

23. The method of claim 22, further comprising acquiring a second criterion based on words constituting the phrase.

24. The method of claim 16, wherein determining the content output scheme comprises changing at least one of words constituting the content, output speed of the content, and output size of the content based on the second criterion, and outputting the content according to the content output scheme.

25. The method of claim 24, further comprising receiving speech of the user, and wherein determining the content output scheme comprises changing, when a phrase acquired from the speech is a request for changing the content output scheme, the content output scheme.

26. The method of claim 16, wherein determining the content output scheme comprises changing the content output scheme determined based on the second criterion using the past content output scheme history of the user.

27. The method of claim 16, further comprising:
receiving a face image of the user; and
automatically acquiring the first criterion based on the face image of the user.

28. The method of claim 27, wherein acquiring the first criterion comprises acquiring the first criterion from predetermined per-emotional state expression information based on facial expressions acquired from the user's face image.

29. The method of claim 16, further comprising:
receiving at least one of a face image and speech of the user; and
automatically acquiring the second criterion based on the at least one of the user's face image and speech.

30. The method of claim 16, further comprising receiving the first and second criteria through the audio processing unit.
